(19) United States
(12) Patent Application Publication
(10) Pub. No.: US 2011/0241645 A1
(43) Pub. Date: Oct. 6, 2011

(54) CURRENT SOURCE CIRCUIT

(75) Inventors: Hiroaki Shimizu, Tokyo (JP); Susumu Hoshino, Kanagawa-ken (JP)

(73) Assignee: KABUSHIKI KAISHA TOSHIBA, Tokyo (JP)

(21) Appl. No.: 13/040,225

(22) Filed: Mar. 3, 2011

(30) Foreign Application Priority Data
Apr. 1, 2010 (JP) 2010-085408

(51) Int. Cl. G05F 3/02

(52) U.S. Cl. 323/312

(57) ABSTRACT

A current source circuit has a voltage application terminal that is applied with a prescribed voltage; an output terminal that outputs the current; a first MOS transistor of which a source is connected to the voltage application terminal; a second MOS transistor of which a source is connected to a drain of the first MOS transistor and a drain is connected to the output terminal; a third MOS transistor of which a source is connected to the voltage application terminal; a fourth MOS transistor of which a source is connected to a drain of the third MOS transistor and a drain is connected to the output terminal. The current source circuit, in a state where the bias voltage is applied to the first input terminal such that the predetermined current flows into the first and fourth MOS transistors, controls turning ON/OFF of the second MOS transistor and the third MOS transistor so as to synchronize according to the switch voltage applied to the second input terminal.

### CROSS-REFERENCE TO RELATED APPLICATION

This application is based upon and claims the benefit of priority from the prior Japanese Patent Application No. 2010-85408, filed on Apr. 1, 2010, the entire contents of which are incorporated herein by reference.

### BACKGROUND

1. Field

Embodiments described herein relate generally to a current source circuit that outputs a current.

2. Background Art

In the conventional art, a current source circuit that supplies an output current to a load connected to an output terminal according to an input signal has been widely used as a basic operation circuit. The output current of the current source circuit is used for ON/OFF control of a laser diode used to perform recording or reading on a CD-ROM, a DVD, and a like.

The current source circuit according to the conventional art has a switch transistor of which a source is connected to a power supply terminal and a gate receives a rectangular-wave control signal; and a constant current source transistor of which a source is connected to a drain of the switch transistor, a drain is connected to an output terminal, and a gate is applied with a bias voltage (fixed voltage).

Hereafter, the operation of the switch transistor when it is turned on in the current source circuit that has the above configuration will be considered.

A state immediately before the switch transistor is turned on is equivalent to a state where a resistor having high resistance is inserted into the source side of the constant current source transistor. In this state, the output current does not flow. Therefore, a source voltage of the constant current source transistor is almost the same as a ground voltage (zero voltage).

If the switch transistor is turned on from the above state using the rectangular-wave control signal, the source voltage of the constant current source transistor instantly increases to a power supply voltage.

However, a parasitic capacity exists between the gate and the source of the constant current source transistor. This parasitic capacity increases a gate voltage, according to an increase in the source voltage of the constant current source transistor.

For this reason, when the switch transistor is turned on, the gate voltage of the constant current source transistor increases. Thereby, in the constant current source transistor, only a current of the amount that is smaller than the amount of current set by a corresponding bias voltage flows.

As such, when the switch transistor is turned on, the current source circuit outputs only an output current of the amount that is smaller than the amount of setting current. That is, even though the control signal changes with a rectangular waveform, the output current does not change with a rectangular waveform.

As described above, in the current source circuit according to the conventional art, it is difficult to output the rectangular-wave output current according to the input of the rectangular-wave signal, due to an influence from the parasitic capacity of the transistor. For example, if the output current does not change with the rectangular waveform, it becomes difficult to perform a desired ON/OFF control of the laser diode.

### BRIEF DESCRIPTION OF THE DRAWINGS

FIG. 1 is a circuit diagram showing an example of the configuration of a current source circuit according to a first embodiment of the present invention;

FIG. 2 is a circuit diagram showing an example of the configuration of a current source circuit according to the second embodiment of the present invention;

FIG. 3 is a circuit diagram showing an example of the configuration of a current source circuit according to the third embodiment of the present invention;

FIG. 4 is a circuit diagram showing an example of the configuration of a current source circuit according to the fourth embodiment of the present invention;

FIG. 5 is a circuit diagram showing an example of the configuration of the current source circuit according to the fifth embodiment of the present invention;

FIG. 6 is a circuit diagram showing an example of the configuration of the current source circuit according to the sixth embodiment of the present invention;

FIG. 7 is a circuit diagram showing an example of the configuration of the current source circuit according to the seventh embodiment of the present invention;

FIG. 8 is a circuit diagram showing an example of the configuration of the current source circuit according to the eighth embodiment of the present invention;

FIG. 9 is a circuit diagram showing an example of the configuration of a current source circuit according to the ninth embodiment of the present invention;

FIG. 10 is a circuit diagram showing an example of the configuration of the current source circuit according to the tenth embodiment of the present invention;

FIG. 11 is a circuit diagram showing an example of the configuration of the current source circuit according to the eleventh embodiment of the present invention;

FIG. 12 is a circuit diagram showing an example of the configuration of a current source circuit according to the twelfth embodiment of the present invention;

FIG. 13 is a circuit diagram showing an example of the specific circuit configuration of the level shift circuit 14a and the inverter 12a; and

FIG. 14 is a circuit diagram showing an example of the specific circuit configuration of the level shift circuit 14b and the inverter 12b.

### DETAILED DESCRIPTION

A current source circuit according to an embodiment, supplies a current to a load connected to an output terminal. The current source circuit comprises a voltage application terminal that is applied with a prescribed voltage. The current source circuit comprises an output terminal that outputs the current. The current source circuit comprises a first MOS transistor of which a source is connected to the voltage application terminal. The current source circuit comprises a second MOS transistor of which a source is connected to a drain of the first MOS transistor and a drain is connected to the output terminal. The current source circuit comprises a third MOS transistor of which a source is connected to the voltage application terminal. The current source circuit comprises a fourth MOS transistor of which a source is connected to a drain of the third MOS transistor and a drain is connected to the output terminal. The current source circuit comprises a first input terminal that is applied with a bias voltage. The current source circuit comprises a resistor that is connected between the first input terminal and gates of the first and fourth MOS transistors. The current source circuit comprises a second input terminal that is connected to gates of the second and third MOS transistors and is applied with a rectangular-wave switch voltage.

Hereinafter, embodiments of the present invention will be described in detail on the basis of the drawings.

### First Embodiment

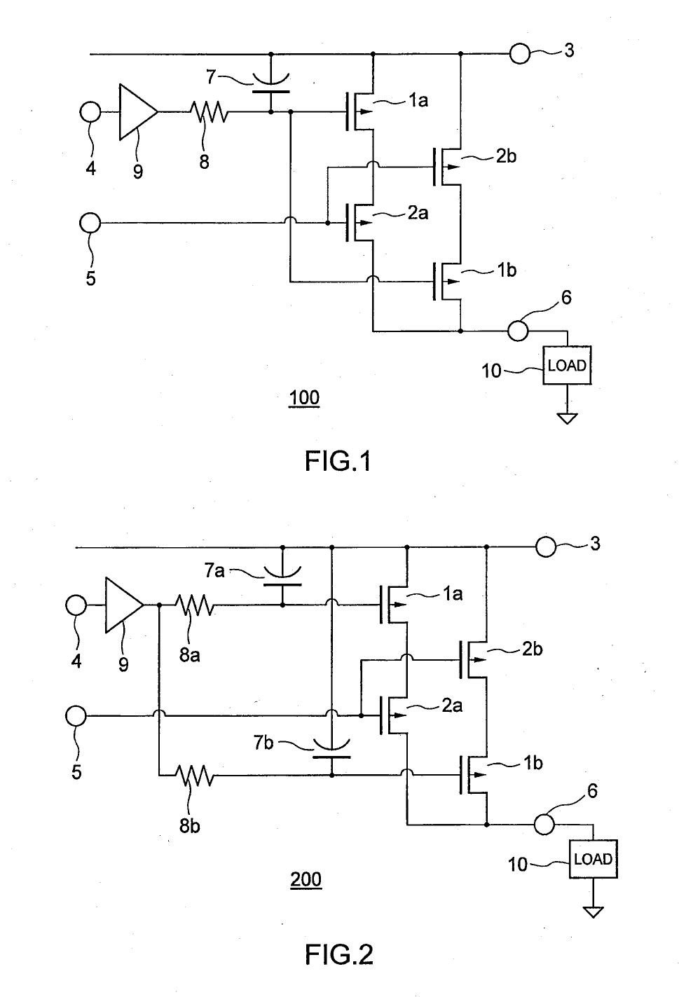

FIG. 1 is a circuit diagram showing an example of the configuration of a current source circuit according to a first embodiment of the present invention.

As shown in FIG. 1, a current source circuit 100 includes a first MOS transistor 1a, a second MOS transistor 2a, a third MOS transistor 2b, a fourth MOS transistor 1b, a voltage application terminal 3, a first input terminal 4, a second input terminal 5, an output terminal 6, a capacitor 7, a resistor 8, and a buffer amplifier 9.

The current source circuit 100 supplies a current to a load 10 connected between the output terminal 6 and a ground, through the output terminal 6. The load 10 is, for example, a laser diode that is used to perform recording or reading on a CD-ROM, a DVD, and the like.

The voltage application terminal 3 is connected to a power supply (not shown in the drawings) and is applied with a prescribed voltage (power supply voltage).

The first input terminal 4 is applied with a fixed bias voltage that is set based on a predetermined output current.

The second input terminal 5 is applied with a rectangular-wave switch voltage (control signal).

As described above, the output terminal 6 is connected to the load 10 and outputs an output current to the load 10.

An input terminal of the buffer amplifier 9 is connected to the first input terminal 4. The buffer amplifier 9 amplifies and outputs the bias voltage that is input through the first input terminal 4.

The resistor 8 is connected between an output terminal of the buffer amplifier 9 and a gate of the first MOS transistor 1a. Also, the resistor 8 is connected between the output terminal of the buffer amplifier 9 and a gate of the fourth MOS transistor 1b.

The capacitor 7 is connected between the voltage application terminal 3 and the gate of the first MOS transistor 1a. Also, the capacitor 7 is connected between the voltage application terminal 3 and the gate of the fourth MOS transistor 1b.

One end (source) of the first MOS transistor 1a is connected to the voltage application terminal 3. A fixed voltage according to the bias voltage is applied to the gate of the first MOS transistor 1a, and the first MOS transistor 1a functions as the constant current source. In this case, the first MOS transistor is a p-channel MOS transistor.

One end (source) of the second MOS transistor 2a is connected to the other end (drain) of the first MOS transistor 1a and the other end thereof is connected to the output terminal 6. Turing ON/OFF of the second MOS transistor 2a is controlled according to the rectangular-wave switch voltage that is input to the gate of the second MOS transistor 2a through the second input terminal 5, and the second MOS transistor 2a functions as a switch. In this case, the second MOS transistor 2a is a conductive p-channel MOS transistor same as the first MOS transistor 1a.

One end (source) of the third MOS transistor 2b is connected to the voltage application terminal 3 and a gate thereof is connected to the gate of the second MOS transistor 2a. Turning ON/OFF of the third MOS transistor 2b is controlled according to the rectangular-wave switch voltage that is input to the gate of the third MOS transistor 2b through the second input terminal 5, and the third MOS transistor 2b functions as a switch. In this case, the third MOS transistor 2b is a conductive p-channel MOS transistor same as the first MOS transistor 1a.

One end (source) of the fourth MOS transistor 1b is connected to the other end (drain) of the third MOS transistor 2b, the other end (drain) thereof is connected to the output terminal 6, and a gate thereof is connected to the gate of the first MOS transistor 1a. The fixed voltage according to the bias voltage is applied to the gate of the fourth MOS transistor 1b, and the fourth MOS transistor 1b functions as the constant current source. The fourth MOS transistor 1b is a conductive p-channel MOS transistor same as the first MOS transistor 1a.

Hereafter, an example of the operation of the current source circuit 100 that has the above configuration will be described.

First, the fixed bias voltage that is set depending on the predetermined output current is applied to the first input terminal 4.

Thereby, the fixed voltage according to the bias voltage is applied to the gate of the first MOS transistor 1a, and the first MOS transistor 1a functions as the constant current source to flow the current according to the fixed voltage. Also, the fixed voltage according to the bias voltage is applied to the gate of the fourth MOS transistor 1b, and the fourth MOS transistor 1b functions as the constant current source to flow the current according to the fixed voltage.

As such, the bias voltage is applied to the first input terminal 4 such that the predetermined current flows into the first MOS transistor 1a and the fourth MOS transistor 1b.

Next, in a state where the bias voltage is applied to the first input terminal 4 such that the predetermined current flows into the first and fourth MOS transistors 1a and 1b, turning ON/OFF of the second MOS transistor 2a and the third MOS transistor 2b is synchronized and controlled, according to the switch voltage applied to the second input terminal 5. That is, when the second MOS transistor 2a is turned on according to the switch voltage, the third MOS transistor 2b is also turned on. When the second MOS transistor 2a is turned off, the third MOS transistor 2b is also turned off.

Therefore, when the second and third MOS transistors 2a and 2b are turned on, a current that corresponds to a sum of the drain currents of the first and fourth MOS transistors 1a and 1b flows into the load 10 as an output current through the output terminal 6.

Meanwhile, when the second and third MOS transistors 2a and 2b are turned off, the drain currents of the first and fourth MOS transistors 1a and 1b are restricted and an output of the current with respect to the load 10 is restricted.

Hereafter, the operation of the current source circuit 100 when the rectangular-wave switch voltage is applied to the second input terminal 5 and the second and third MOS transistors 2a and 2b are turned on will be described in detail.

First, in a state where the second MOS transistor 2a is turned off, the drain voltage of the first MOS transistor 1a is almost the same as the power supply voltage. When the second MOS transistor 2a is turned on, the drain voltage of the first MOS transistor 1a is decreased to the voltage of the load 10. At this stage, the capacity (parasitic capacity) between the gate and the drain of the first MOS transistor 1a attempts to decrease the gate voltage of the first and fourth MOS transistors 1a and 1b.

Meanwhile, when the third MOS transistor 2b is turned off, the source voltage of the fourth MOS transistor 1b is almost the same as ground voltage. When the third MOS transistor 2b is turned on, the source voltage increases to the power supply voltage. At this stage, the capacity (parasitic capacity) between the gate and the source of the fourth MOS transistor 1b attempts to increase the gate voltage of the first and fourth MOS transistors 1a and 1b.

As such, when the second and third MOS transistors 2a and 2b are turned on according to the rectangular-wave switch voltage, the capacity (parasitic capacity) between the gate and the drain of the first MOS transistor 1a attempts to decrease the gate voltage of the first and fourth MOS transistors 1a and 1b, and the capacity (parasitic capacity) between the gate and the source of the fourth MOS transistor 1b attempts to increase the gate voltage of the first and fourth MOS transistors 1a and 1b.

As a result, an impact on the gate voltage by the capacity between the gate and the drain and an impact on the gate voltage by the capacity between the gate and the source are offset. That is, even when the second and third MOS transistors 2a and 2b are turned on, the gate voltages of the first and fourth MOS transistors 1a and 1b rarely change.

Therefore, when the second and third MOS transistors 2a and 2b are turned on, the first and fourth MOS transistors 1a and 1b can flow the predetermined current according to the bias voltage.

That is, the current source circuit 100 can perform an ON/OFF control on the output current with almost the rectangular waveform, according to the rectangular-wave switch voltage.

As such, according to the current source circuit according to the present embodiment, the waveform of the output current that is output according to the input of the rectangular-wave signal can be approximated to the rectangular wave.

### Second Embodiment

In a second embodiment, an example of the configuration where resistors and capacitors are distributed to MOS transistors of two constant current sources will be described.

FIG. 2 is a circuit diagram showing an example of the configuration of a current source circuit according to the second embodiment of the present invention. In FIG. 2, the same reference numerals as those of FIG. 1 denote the same components as those of the first embodiment.

As shown in FIG. 2, a current source circuit 200 includes a first MOS transistor 1a, a second MOS transistor 2a, a third MOS transistor 2b, a fourth MOS transistor 1b, a voltage application terminal 3, a first input terminal 4, a second input terminal 5, an output terminal 6, a first capacitor 7a, a second capacitor 7b, a first resistor 8a, a second resistor 8b, and a buffer amplifier 9.

The first resistor 8a is connected to an output terminal of the buffer amplifier 9 and a gate of the first MOS transistor 1a. The second resistor 8b is connected between the output terminal of the buffer amplifier 9 and a gate of the fourth MOS transistor 1b.

The first capacitor 7a is connected between the voltage application terminal 3 and the gate of the first MOS transistor 1a. The second capacitor 7b is connected between the voltage application terminal 3 and the gate of the fourth MOS transistor 1b.

As such, in the current source circuit 200 of FIG. 2, the resistor 8 and the capacitor 7 shown in FIG. 1 are divided into the first and second resistors 8a and 8b and the first and second capacitors 7a and 7b, and the first and second resistors 8a and 8b and the first and second capacitors 7a and 7b are distributed to the first and fourth MOS transistors 1a and 1b. Therefore, the gate of the first MOS transistor 1a and the gate of the fourth MOS transistor 1b are connected to each other through the first and second resistors 8a and 8b. The rest of the configuration of the current source circuit 200 is the same as that of the first embodiment.

Similar to the first embodiment, the current source circuit 200 supplies a current to the load 10 connected between the output terminal 6 and the ground, through the output terminal 6.

The operation of the current source circuit 200 that has the above configuration is basically the same as that of the current source circuit 100 according to the first embodiment.

That is, similar to the first embodiment, in a state where the bias voltage is applied to the first input terminal 4 such that the predetermined current flows into the first and fourth MOS transistors 1a and 1b, turning ON/OFF of the second MOS transistor 2a and the third MOS transistor 2b is synchronized and controlled, according to the switch voltage applied to the second input terminal 5.

Hereafter, the operation of the current source circuit 200 when the rectangular-wave switch voltage is applied to the second input terminal 5 and the second and third MOS transistors 2a and 2b are turned on will be described in detail.

First, in a state where the second MOS transistor 2a is turned off, the drain voltage of the first MOS transistor 1a is almost the same as power supply voltage. When the second MOS transistor 2a is turned on, the drain voltage of the first MOS transistor 1a decreases to the voltage of the load 10. At this stage, the capacity (parasitic capacity) between the gate and the drain of the first MOS transistor 1a attempts to decrease the gate voltage of the first MOS transistor 1a.

Thereby, when the second MOS transistor 2a is turned on, the drain current of the first MOS transistor 1a becomes more than a normal current (normal drain current of the first MOS transistor 1a when the fixed voltage is applied to the gate).

Meanwhile, when the third MOS transistor 2b is turned off, the source voltage of the fourth MOS transistor 1b is almost the same as ground voltage. When the third MOS transistor 2b is turned on, the source voltage increases to the power supply voltage. At this stage, the capacity (parasitic capacity) between the gate and the source of the fourth MOS transistor 1b attempts to increase the gate voltage of the fourth MOS transistor 1b.

Thereby, when the third MOS transistor 2b is turned on, the drain current of the fourth MOS transistor 1b becomes less than a normal current (normal drain current of the fourth MOS transistor 1b when the fixed voltage is applied to the gate).

That is, when the second and third MOS transistors 2a and 2b are turned on, an increased amount of the drain current of the first MOS transistor 1a and a decreased amount of the drain current of the fourth MOS transistor 1b are offset. Thereby, an impact of the parasitic capacity on a sum (output current supplied to the load 10) of the drain currents of the first and fourth MOS transistors 1a and 1b is decreased.

Therefore, the current source circuit 200 can perform an ON/OFF control on the output current with almost the rectangular waveform, according to the rectangular-wave switch voltage.

As such, according to the current source circuit according to the present embodiment, the waveform of the output current that is output according to the input of the rectangular-wave signal can be approximated to the rectangular wave.

In the configuration according to the second embodiment, even when a size of the first MOS transistor 1a and a size of the fourth MOS transistor 1b are set to be different from each other, and the capacity between the gate and the drain of each MOS transistor and the capacity between the gate and the source of each MOS transistor are different from each other, resistance values of the resistors 8a and 8b can be independently set.

Therefore, a time constant based on the resistor 8a and the capacity between the gate and the drain of the first MOS transistor 1a, and a time constant based on the resistor 8b and the capacity between the gate and source of the fourth MOS transistor 1b and the capacity between the gate and the drain thereof can be independently set.

Thereby, in the configuration according to the second embodiment, the output current can be further approximated to the output of the rectangular-wave current, as compared with the configuration according to the first embodiment.

### Third Embodiment

In a third embodiment, an example of the configuration where one column of the MOS transistors functioning as the switches and the MOS transistors functioning as the constant current sources is omitted from the configuration according to the second embodiment will be described.

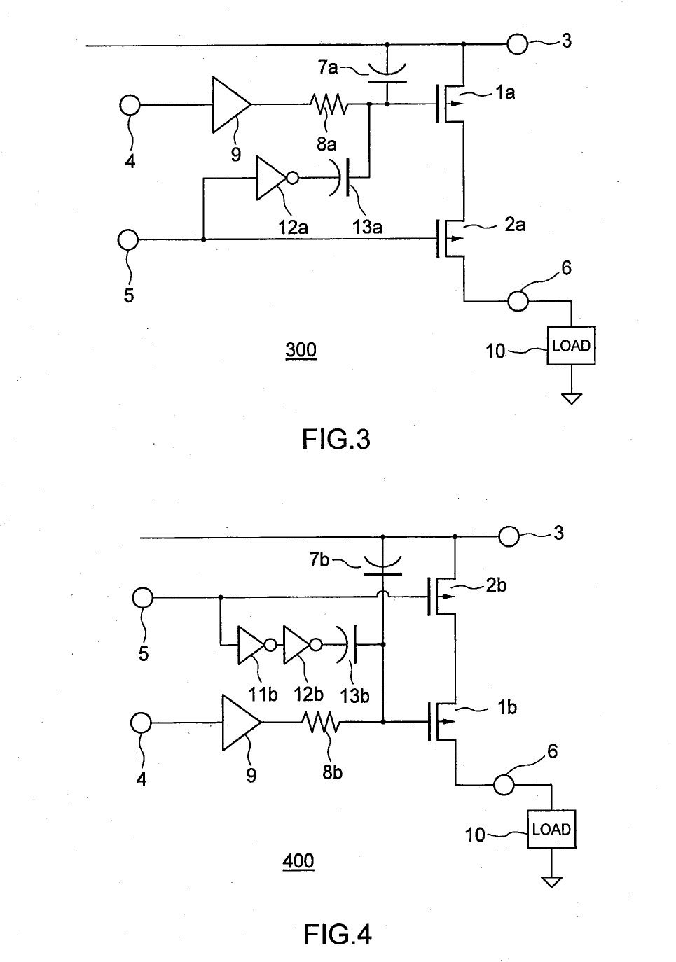

FIG. 3 is a circuit diagram showing an example of the configuration of a current source circuit according to the third embodiment of the present invention. In FIG. 3, the same reference numerals as those of FIG. 2 denote the same components as those of the second embodiment.

As shown in FIG. 3, a current source circuit 300 does not include the capacitor 7b, the resistor 8b, and the MOS transistors 1b and 2b, as compared with the current source circuit 200 of FIG. 2. Meanwhile, the current source circuit 300 further includes an inverter 12a and a capacitor 13a, as compared with the current source circuit 200 of FIG. 2. The rest of the configuration of the current source circuit 300 is the same as that of the current source circuit 200 according to the second embodiment.

An input terminal of the inverter 12a is connected to the second input terminal 5.

The capacitor 13a is connected between an output terminal of the inverter 12a and a gate of the first MOS transistor 1a.

Similar to the second embodiment, the current source circuit 300 supplies a current to the load 10 connected between the output terminal 6 and the ground, through the output terminal 6.

The operation of the current source circuit 300 that has the above configuration is basically the same as that of the current source circuit 200 according to the second embodiment.

That is, similar to the second embodiment, in a state where the bias voltage is applied to the first input terminal 4 such that the predetermined current flows into the first MOS transistor 1a, turning ON/OFF of the second MOS transistor 2a is controlled, according to the switch voltage applied to the second input terminal 5.

In this case, the operation of the current source circuit 300 when the rectangular-wave switch voltage is applied to the second input terminal 5 and the second MOS transistor 2a is turned on is basically the same as that of the current source circuit 200 according to the second embodiment.

That is, first, in a state where the second MOS transistor 2a is turned off, the drain voltage of the first MOS transistor 1a is almost the same as the power supply voltage. When the second MOS transistor 2a is turned on, the drain voltage of the first MOS transistor 1a decreases to the voltage of the load 10. At this stage, the capacity (parasitic capacity) between the gate and the drain of the first MOS transistor 1a attempts to decrease the gate voltage of the first MOS transistor 1a.

In this case, different from the second embodiment, when the second MOS transistor 2a is turned on, an output of the inverter 12a increases, additionally. Thereby, the capacitor 13a attempts to increase a gate voltage of the first MOS transistor 1a.

That is, a function of the capacity (parasitic capacity) between the gate and the drain of the first MOS transistor 1a that causes the gate voltage of the first MOS transistor 1a to be lower than the normal voltage is cancelled by a function of the capacitor 13a that causes the gate voltage to be higher than the normal voltage.

Therefore, the current source circuit 300 can perform an ON/OFF control on the output current such that the waveform of the output current is approximated to the rectangular wave, according to the rectangular-wave switch voltage.

As such, according to the current source circuit according to the present embodiment, the waveform of the output current that is output according to the input of the rectangular-wave signal can be approximated to the rectangular wave.

### Fourth Embodiment

In a fourth embodiment, another example of the configuration where one column of the MOS transistors functioning as the switches and the MOS transistors functioning as the constant current sources is omitted from the configuration according to the second embodiment will be described.

FIG. 4 is a circuit diagram showing an example of the configuration of a current source circuit according to the fourth embodiment of the present invention. In FIG. 4, the same reference numerals as those of FIG. 2 denote the same components as those of the second embodiment.

As shown in FIG. 4, a current source circuit 400 does not include the capacitor 7a, the resistor 8a, and the first and second MOS transistors 1a and 2a, as compared with the current source circuit 200 of FIG. 2. Meanwhile, the current source circuit 400 further includes inverters 11b and 12b and a capacitor 13b, as compared with the current source circuit 200 of FIG. 2. The rest of the configuration of the current source circuit 400 is the same as that of the current source circuit 200 according to the second embodiment.

An input terminal of the inverter 11b is connected to the second input terminal 5. An input terminal of the inverter 12b is connected to an output terminal of the inverter 11b.

The capacitor 13b is connected to an output terminal of the inverter 12b and the gate of the fourth MOS transistor 1b.

Similar to the second embodiment, the current source circuit 400 supplies a current to the load 10 connected between the output terminal 6 and the ground, through the output terminal 6.

The operation of the current source circuit 400 that has the above configuration is basically the same as that of the current source circuit 200 according to the second embodiment.

That is, similar to the second embodiment, in a state where the bias voltage is applied to the first input terminal 4 such that the predetermined current flows into the fourth MOS transistor 1b, turning ON/OFF of the third MOS transistor 2b is controlled, according to the switch voltage applied to the second input terminal 5.

In this case, the operation of the current source circuit 400 when the rectangular-wave switch voltage is applied to the second input terminal 5 and the third MOS transistor 2b is turned on is basically the same as that of the current source circuit 200 according to the second embodiment.

First, in a state where the third MOS transistor 2b is turned off, the source voltage of the fourth MOS transistor 1b is almost the same as the ground voltage. When the third MOS transistor 2b is turned on, the source voltage increases to the power supply voltage. At this stage, the capacity (parasitic capacity) between the gate and the source of the fourth MOS transistor 1b attempts to increase the gate voltage of the fourth MOS transistor 1b.

When the third MOS transistor 2b is turned on, an output of the inverter 12b decreases. Thereby, the capacitor 13b attempts to decreases a gate voltage of the fourth MOS transistor 1b.

That is, a function of the capacity (parasitic capacity) between the gate and the source of the fourth MOS transistor 1b that causes the gate voltage of the fourth MOS transistor 1b to be higher than the normal voltage is cancelled by a function of the capacitor 13b that causes the gate voltage to be lower than the normal voltage.

Therefore, the current source circuit 400 can perform an ON/OFF control on the output current such that the waveform of the output current is approximated to the rectangular wave, according to the rectangular-wave switch voltage.

As such, according to the current source circuit according to the present embodiment, the waveform of the output current that is output according to the input of the rectangular-wave signal can be approximated to the rectangular wave.

### Fifth Embodiment

In a fifth embodiment, an example of the configuration where an impact of the parasitic capacity of the MOS transistor on a current source circuit according to the third embodiment is further decreased will be described.

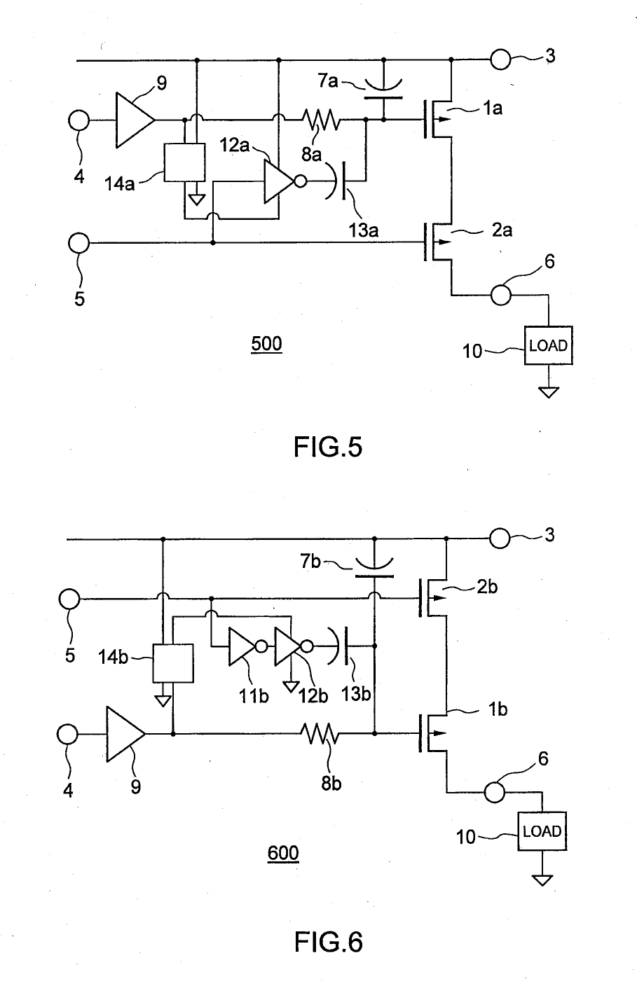

FIG. 5 is a circuit diagram showing an example of the configuration of the current source circuit according to the fifth embodiment of the present invention. In FIG. 5, the same reference numerals as those of FIG. 3 denote the same components as those of the third embodiment.

As shown in FIG. 5, a current source circuit 500 further includes a level shift circuit 14a, as compared with the current source circuit 300 of FIG. 3. The rest of the configuration of the current source circuit 500 is the same as that of the current source circuit 300 according to the third embodiment.

The level shift circuit 14a is connected between an output terminal of the buffer amplifier 9 and a power supply terminal on a low-potential-side of the inverter 12a. The level shift circuit 14a controls amplitude of the inverter 12a according to an output of the buffer amplifier 9 (that is, according to the bias voltage).

For example, when the bias voltage is set such that the output current increases, the level shift circuit 14a increases a low-potential-side level of output levels of the inverter 12a to decrease the amplitude of the inverter 12a. Meanwhile, when the bias voltage is set such that the output current decreases, the level shift circuit 14a decreases the low-potential-side level of the output levels of the inverter 12a to increase the amplitude of the inverter 12a.

Similar to the third embodiment, the current source circuit 500 supplies a current to the load 10 connected between the output terminal 6 and the ground, through the output terminal 6.

The operation of the current source circuit 500 that has the above configuration is basically the same as that of the current source circuit 300 according to the third embodiment.

That is, similar to the third embodiment, in a state where the bias voltage is applied to the first input terminal 4 such that the predetermined current flows into the first MOS transistor 1a, turning ON/OFF of the second MOS transistor 2a is controlled, according to the switch voltage applied to the second input terminal 5.

The operation of the current source circuit 500 when the rectangular-wave switch voltage is applied to the second input terminal 5 and the second MOS transistor 2a is turned on is basically the same as that of the current source circuit 300 according to the third embodiment.

In this case, when a state of the second MOS transistor 2a is switched from an OFF state to an ON state, the drain voltage of the first MOS transistor 1a decreases from the power supply voltage to the voltage of the load 10. The voltage of the load 10 increases as the output current increases.

Therefore, when the output current increases, a variation width of the drain voltage of the first MOS transistor 1a decreases.

Therefore, in the fifth embodiment, as described above, the output amplitude of the inverter 12a is controlled by the level shift circuit 14a, such that the output amplitude decreases as the output current increases. Thereby, an increase ratio of the gate voltage of the first MOS transistor 1a that is increased by the capacitor 13a is decreased.

That is, when the variation width of the drain voltage of the first MOS transistor 1a decreases, an increase ratio of the gate voltage of the first MOS transistor 1a that is increased by the capacitor 13a is decreased. Thereby, the magnitude of the function of the capacitor 13a and the magnitude of the function of the parasitic capacity can be approximated to each other.

Therefore, the current source circuit 500 can perform an ON/OFF control on the output current such that the waveform of the output current is approximated to the rectangular wave, according to the rectangular-wave switch voltage.

As such, according to the current source circuit according to the present embodiment, the waveform of the output current that is output according to the input of the rectangular-wave signal can be approximated to the rectangular wave.

### Sixth Embodiment

In a sixth embodiment, an example of the configuration where an impact of the parasitic capacity of the MOS transistor on a current source circuit according to the fourth embodiment is further decreased will be described.

FIG. 6 is a circuit diagram showing an example of the configuration of the current source circuit according to the sixth embodiment of the present invention. In FIG. 6, the same reference numerals as those of FIG. 4 denote the same components as those of the fourth embodiment.

As shown in FIG. 6, a current source circuit 600 further includes a level shift circuit 14b, as compared with the current source circuit 400 of FIG. 4. The rest of the configuration of the current source circuit 600 is the same as that of the current source circuit 400 according to the fourth embodiment.

The level shift circuit 14b is connected between an output terminal of the buffer amplifier 9 and a power supply terminal on a high-potential-side of the inverter 12b. The level shift circuit 14b controls amplitude of the inverter 12b according to an output of the buffer amplifier 9 (that is, according to the bias voltage).

For example, when the bias voltage is set such that the output current increases, the level shift circuit 14b increases a high-potential-side level of output levels of the inverter 12b to increase the amplitude of the inverter 12b. Meanwhile, when the bias voltage is set such that the output current decreases, the level shift circuit 14b decreases the high-potential-side level of the output levels of the inverter 12b to decrease the amplitude of the inverter 12b.

Similar to the fourth embodiment, the current source circuit 600 supplies a current to the load 10 connected between the output terminal 6 and the ground, through the output terminal 6.

The operation of the current source circuit 600 that has the above configuration is basically the same as that of the current source circuit 400 according to the fourth embodiment.

That is, similar to the fourth embodiment, in a state where the bias voltage is applied to the first input terminal 4 such that the predetermined current flows into the fourth MOS transistor 1b, turning ON/OFF of the third MOS transistor 2b is controlled, according to the switch voltage applied to the second input terminal 5.

The operation of the current source circuit 600 when the rectangular-wave switch voltage is applied to the second input terminal 5 and the third MOS transistor 2b is turned on is basically the same as that of the current source circuit 400 according to the fourth embodiment.

In this case, when a state of the third MOS transistor 2b is switched from an OFF state to an ON state, the drain voltage of the fourth MOS transistor 1b increases from the ground voltage (zero voltage) to the voltage of the load 10. The voltage of the load 10 increases as the output current increases.

Therefore, as the output current increases, a variation width of the drain voltage of the fourth MOS transistor 1b increases.

Therefore, in the sixth embodiment, as described above, the output amplitude of the inverter 12b is controlled by the level shift circuit 14b, such that the output amplitude increases as the output current increases. Thereby, an increase ratio of the gate voltage of the fourth MOS transistor 1b that is increased by the capacitor 13b is increased.

That is, when the variation width of the drain voltage of the fourth MOS transistor 1b increases, an increase ratio of the gate voltage of the fourth MOS transistor 1b that is increased by the capacitor 13b is increased. Thereby, the magnitude of the function of the capacitor 13b and the magnitude of the function of the parasitic capacity can be approximated to each other.

Therefore, the current source circuit 600 can perform an ON/OFF control on the output current such that the waveform of the output current is approximated to the rectangular wave, according to the rectangular-wave switch voltage.

As such, according to the current source circuit according to the present embodiment, the waveform of the output current that is output according to the input of the rectangular-wave signal can be approximated to the rectangular wave.

### Seventh Embodiment

In a seventh embodiment, an example of the configuration where an impact of the parasitic capacity of the MOS transistor on a current source circuit according to the second embodiment is further decreased will be described.

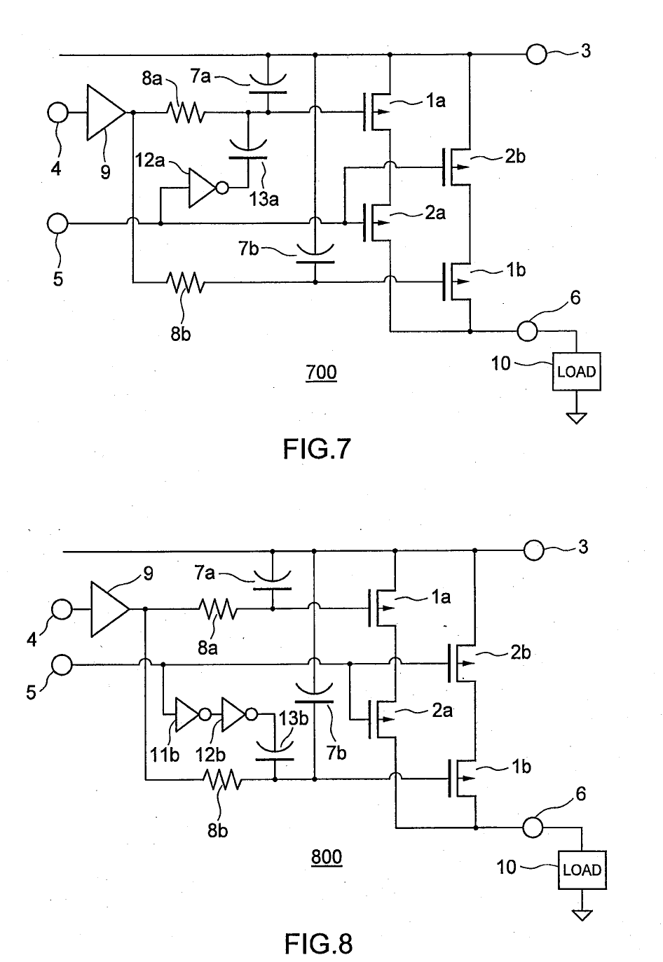

FIG. 7 is a circuit diagram showing an example of the configuration of the current source circuit according to the seventh embodiment of the present invention. In FIG. 7, the same reference numerals as those of FIGS. 2 and 3 denote the same components as those of the second and third embodiments.

As shown in FIG. 7, a current source circuit 700 further includes an inverter 12a and a capacitor 13a, as compared with the current source circuit 200 of FIG. 2. The rest of the configuration of the current source circuit 700 is the same as that of the current source circuit 200 according to the second embodiment.

An input terminal of the inverter 12a is connected to the second input terminal 5.

The capacitor 13a is connected between an output terminal of the inverter 12a and the gate of the first MOS transistor 1a.

Similar to the second embodiment, the current source circuit 700 supplies a current to the load 10 connected between the output terminal 6 and the ground, through the output terminal 6.

The operation of the current source circuit 700 that has the above configuration is basically the same as that of the current source circuit 200 according to the second embodiment.

That is, similar to the second embodiment, in a state where the bias voltage is applied to the first input terminal 4 such that the predetermined current flows into the first and fourth MOS transistors 1a and 1b, turning ON/OFF of the second and third MOS transistors 2a and 2b is synchronized and controlled, according to the switch voltage applied to the second input terminal 5.

In this case, the operation of the current source circuit 700 of when the rectangular-wave switch voltage is applied to the second input terminal 5 and the second and third MOS transistors 2a and 2b are turned on is basically the same as that of the current source circuit 200 according to the second embodiment.

That is, first, in a state where the second MOS transistor 2a is turned off, the drain voltage of the first MOS transistor 1a is almost the same as the power supply voltage. When the second MOS transistor 2a is turned on, the drain voltage of the first MOS transistor 1a decreases to the voltage of the load 10. At this stage, the capacity (parasitic capacity) between the gate and the drain of the first MOS transistor 1a attempts to decrease the gate voltage of the first MOS transistor 1a.

Thereby, when the second MOS transistor 2a is turned on, the drain current of the first MOS transistor 1a becomes more than a normal current (normal drain current of the first MOS transistor 1a when the fixed voltage is applied to the gate).

Meanwhile, when the third MOS transistor 2b is turned off, the source voltage of the fourth MOS transistor 1b is almost the same as the ground voltage. When the third MOS transistor 2b is turned on, the source voltage increases to the power supply voltage. At this stage, the capacity (parasitic capacity) between the gate and the source of the fourth MOS transistor 1b attempts to increase the gate voltage of the fourth MOS transistor 1b.

Thereby, when the third MOS transistor 2b is turned on, the drain current of the fourth MOS transistor 1b becomes less than a normal current (normal drain current of the fourth MOS transistor 1b when the fixed voltage is applied to the gate).

That is, when the second and third MOS transistors 2a and 2b are turned on, an increased amount of the drain current of the first MOS transistor 1a and a decreased amount of the drain current of the fourth MOS transistor 1b are offset.

Thereby, an impact of the parasitic capacity on a sum (output current supplied to the load 10) of the drain currents of the first and fourth MOS transistors 1a and 1b is decreased.

In this case, different from the second embodiment, when the second MOS transistor 2a is turned on, an output of the inverter 12a increases. Thereby, the capacitor 13a attempts to increase a gate voltage of the first MOS transistor 1a.

That is, a function of the capacity (parasitic capacity) between the gate and the drain of the first MOS transistor 1a that causes the gate voltage of the first MOS transistor 1a to be lower than the normal voltage is cancelled by a function of the capacitor 13a that causes the gate voltage to be higher than the normal voltage.

Thereby, when the second MOS transistor 2a is turned on, the increased amount of the drain current of the first MOS transistor 1a decreases.

Therefore, the current source circuit 700 can perform an ON/OFF control on the output current such that the waveform of the output current is approximated to the rectangular wave, according to the rectangular-wave switch voltage.

As such, according to the current source circuit according to the present embodiment, the waveform of the output current that is output according to the input of the rectangular-wave signal can be approximated to the rectangular wave.

### Eighth Embodiment

In the eighth embodiment, another example of the configuration where an impact of the parasitic capacity of the MOS transistor on a current source circuit according to the second embodiment is further decreased will be described.

FIG. 8 is a circuit diagram showing an example of the configuration of the current source circuit according to the eighth embodiment of the present invention. In FIG. 8, the same reference numerals as those of FIGS. 2 and 4 denote the same components as those of the second and fourth embodiments.

As shown in FIG. 8, a current source circuit 800 further includes an inverter 11b, an inverter 12b, and a capacitor 13b, as compared with the current source circuit 200 of FIG. 2. The other configuration of the current source circuit 800 is the same as that of the current source circuit 200 according to the second embodiment.

An input terminal of the inverter 11b is connected to the second input terminal 5. An input terminal of the inverter 12b is connected to an output terminal of the inverter 11b.

The capacitor 13b is connected between an output terminal of the inverter 12b and the gate of the fourth MOS transistor 1b.

Similar to the second embodiment, the current source circuit 800 supplies a current to the load 10 connected between the output terminal 6 and the ground, through the output terminal 6.

The operation of the current source circuit 800 that has the above configuration is basically the same as that of the current source circuit 200 according to the second embodiment.

That is, similar to the second embodiment, in a state where the bias voltage is applied to the first input terminal 4 such that the predetermined current flows into the first and fourth MOS transistors 1a and 1b, turning ON/OFF of the second and third MOS transistors 2a and 2b is synchronized and controlled, according to the switch voltage applied to the second input terminal 5.

In this case, the operation of the current source circuit 800 of when the rectangular-wave switch voltage is applied to the second input terminal 5 and the second and third MOS transistors 2a and 2b are turned on is basically the same as that of the current source circuit 200 according to the second embodiment.

First, in a state where the second MOS transistor 2a is turned off, the drain voltage of the first MOS transistor 1a is almost the power supply voltage. When the second MOS transistor 2a is turned on, the drain voltage of the first MOS transistor 1a decreases to the voltage of the load 10. At this time, the capacity (parasitic capacity) between the gate and the drain of the first MOS transistor 1a decreases the gate voltage of the first MOS transistor 1a.

Thereby, when the second MOS transistor 2a is turned on, the drain current of the first MOS transistor 1a becomes more than a normal current (normal drain current of the first MOS transistor 1a when the fixed voltage is applied to the gate).

Meanwhile, when the third MOS transistor 2b is turned off, the source voltage of the fourth MOS transistor 1b is almost the ground voltage. When the third MOS transistor 2b is turned on, the source voltage increases to the power supply voltage. At this time, the capacity (parasitic capacity) between the gate and the source of the fourth MOS transistor 1b increases the gate voltage of the fourth MOS transistor 1b.

Thereby, when the third MOS transistor 2b is turned on, the drain current of the fourth MOS transistor 1b becomes less than a normal current (normal drain current of the fourth MOS transistor 1b when the fixed voltage is applied to the gate).

That is, when the second and third MOS transistors 2a and 2b are turned on, an increased amount of the drain current of the first MOS transistor 1a and a decreased amount of the drain current of the fourth MOS transistor 1b are offset.

Thereby, an influence of the parasitic capacity on a sum (output current supplied to the load 10) of the drain currents of the first and fourth MOS transistors 1a and 1b is decreased.

In this case, different from the second embodiment, when the third MOS transistor 2b is turned on, an output voltage of the inverter 12b decreases. Thereby, the capacitor 13b decreases a gate voltage of the fourth MOS transistor 1b.

That is, a function of the capacity (parasitic capacity) between the gate and the source of the fourth MOS transistor 1b that causes the gate voltage of the fourth MOS transistor 1b to be higher than the normal voltage is cancelled by a function of the capacitor 13b that causes the gate voltage to be lower than the normal voltage.

Thereby, when the third MOS transistor 2b is turned on, the decreased amount of the drain current of the fourth MOS transistor 1b decreases.

Therefore, the current source circuit 800 can perform ON/OFF control on the output current such that the waveform of the output current is approximated to the rectangular wave, according to the rectangular-wave switch voltage.

As such, according to the current source circuit according to this embodiment, the waveform of the output current that is output according to the input of the rectangular-wave signal can be approximated to the rectangular wave.

### Ninth Embodiment

In a ninth embodiment, an example of the configuration where the configurations of the seventh and eighth embodiments are combined will be described.

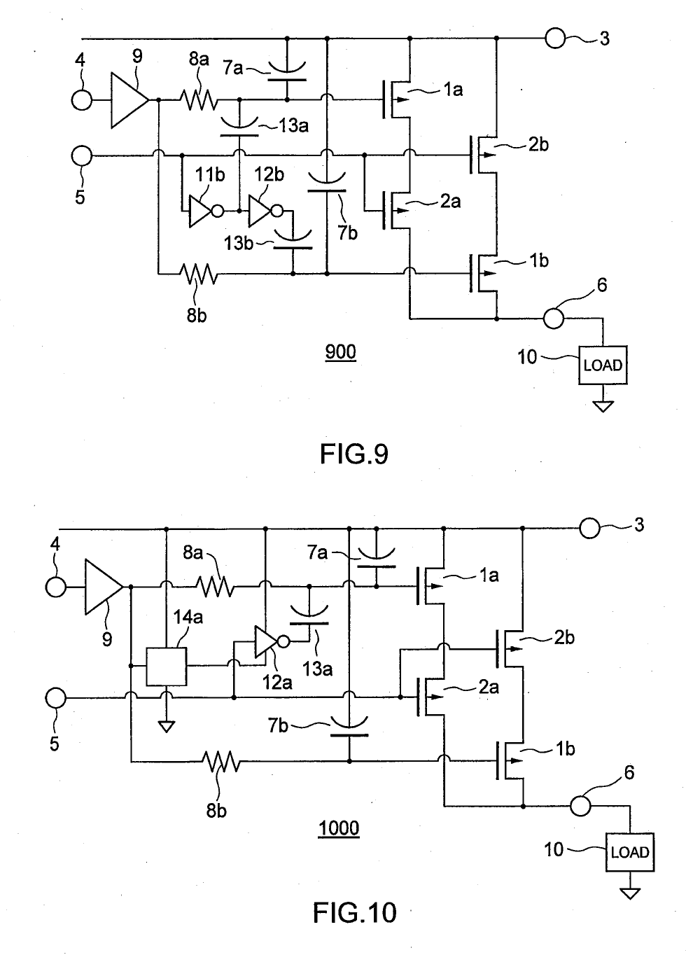

FIG. 9 is a circuit diagram showing an example of the configuration of a current source circuit according to the ninth embodiment of the present invention. In FIG. 9, the same reference numerals as those of FIGS. 7 and 8 denote the same components as those of the seventh and eighth embodiments.

As shown in FIG. 9, the current source circuit 900 further includes a capacitor 13a, as compared with the current source circuit 800 of FIG. 8. The rest of the configuration of the current source circuit 900 is the same as that of the current source circuit 800 according to the eighth embodiment.

As shown in FIG. 9, the capacitor 13a is connected between an output terminal of the inverter 11b and the gate of the first MOS transistor 1a.

Similar to the eighth embodiment, the current source circuit 900 supplies a current to the load 10 connected between the output terminal 6 and the ground, through the output terminal 6.

The operation of the current source circuit 900 that has the above configuration is basically the same as that of the current source circuit 800 according to the eighth embodiment.

That is, similar to the eighth embodiment, in a state where the bias voltage is applied to the first input terminal 4 such that the predetermined current flows into the first and fourth MOS transistors 1a and 1b, turning ON/OFF of the second MOS transistor 2a and the third MOS transistor 2b is synchronized and controlled, according to the switch voltage applied to the second input terminal 5.

In this case, the operation of the current source circuit 900 when the rectangular-wave switch voltage is applied to the second input terminal 5 and the second and third MOS transistors 2a and 2b are turned on is basically the same as that of the current source circuit 800 according to the eighth embodiment.

That is, first, in a state where the second MOS transistor 2a is turned off, the drain voltage of the first MOS transistor 1a is almost the same as the power supply voltage. When the second MOS transistor 2a is turned on, the drain voltage of the first MOS transistor 1a decreases to the voltage of the load 10. At this stage, the capacity (parasitic capacity) between the gate and the drain of the first MOS transistor 1a attempts to decrease the gate voltage of the first MOS transistors la.

Thereby, when the second MOS transistor 2a is turned on, the drain current of the first MOS transistor 1a becomes more than a normal current (normal drain current of the first MOS transistor 1a when the fixed voltage is applied to the gate).

Meanwhile, when the third MOS transistor 2b is turned off, the source voltage of the fourth MOS transistor 1b is almost the same as the ground voltage. When the third MOS transistor 2b is turned on, the source voltage increases to the power supply voltage. At this stage, the capacity (parasitic capacity) between the gate and the source of the fourth MOS transistor 1b attempts to increase the gate voltage of the fourth MOS transistor 1b.

Thereby, when the third MOS transistor 2b is turned on, the drain current of the fourth MOS transistor 1b becomes less than a normal current (normal drain current of the fourth MOS transistor 1b when the fixed voltage is applied to the gate).

That is, when the second and third MOS transistors 2a and 2b are turned on, an increased amount of the drain current of the first MOS transistor 1a and an increased amount of the drain current of the fourth MOS transistor 1b are offset.

Thereby, an impact of the parasitic capacity on a sum (output current supplied to the load 10) of the drain currents of the first and fourth MOS transistors 1a and 1b is decreased.

In this case, when the second MOS transistor 2a is turned on, an output of the inverter 11b increases. Thereby, the capacitor 13a increases the gate voltage of the first MOS transistor 1a.

That is, a function of the capacity (parasitic capacity) between the gate and the drain of the first MOS transistor 1a that causes the gate voltage of the first MOS transistor 1a to be lower than the normal voltage is cancelled by a function of the capacitor 13a that causes the gate voltage to be higher than the normal voltage.

Thereby, when the second MOS transistor 2a is turned on, the increased amount of the drain current of the first MOS transistor 1a decreases.

Meanwhile, when the third MOS transistor 2b is turned on, the output of the inverter 12b decreases. Thereby, the capacitor 13b attempts to decreases the gate voltage of the fourth MOS transistor 1b.

That is, a function of the capacity (parasitic capacity) between the gate and the source of the fourth MOS transistor 1b that causes the gate voltage of the fourth MOS transistor 1b to be higher than the normal voltage is cancelled by a function of the capacitor 13b that causes the gate voltage to be lower than the normal voltage.

Thereby, when the third MOS transistor 2b is turned on, the decreased amount of the drain current of the fourth MOS transistor 1b decreases.

Therefore, the current source circuit 900 can perform an ON/OFF control on the output current such that the waveform of the output current is approximated to the rectangular wave, according to the rectangular-wave switch voltage.

As such, according to the current source circuit according to the present embodiment, the waveform of the output current that is output according to the input of the rectangular-wave signal can be approximated to the rectangular wave.

### Tenth Embodiment

In a tenth embodiment, an example of the configuration where an impact of the parasitic capacity of the MOS transistor on a current source circuit according to the seventh embodiment is further decreased will be described.

FIG. 10 is a circuit diagram showing an example of the configuration of the current source circuit according to the tenth embodiment of the present invention. In FIG. 10, the same reference numerals as those of FIG. 7 denote the same components as those of the seventh embodiment.

As shown in FIG. 10, a current source circuit 1000 further includes a level shift circuit 14a, as compared with the current source circuit 700 of FIG. 7. The rest of the configuration of the current source circuit 1000 is the same as that of the current source circuit 700 according to the seventh embodiment.

The level shift circuit 14a is connected between an output terminal of the buffer amplifier 9 and a power supply terminal on a low-potential-side of the inverter 12a. The level shift circuit 14a controls amplitude of the inverter 12a according to an output of the buffer amplifier 9 (that is, according to the bias voltage).

For example, when the bias voltage is set such that the output current increases, the level shift circuit 14a increases a low-potential-side level of output levels of the inverter 12a to decrease the amplitude of the inverter 12a. Meanwhile, when the bias voltage is set such that the output current decreases, the level shift circuit 14a decreases the low-potential-side level of the output levels of the inverter 12a to increase the amplitude of the inverter 12a.

Similar to the seventh embodiment, the current source circuit 1000 supplies a current to the load 10 connected between the output terminal 6 and the ground, through the output terminal 6.

The operation of the current source circuit 1000 that has the above configuration is basically the same as that of the current source circuit 700 according to the seventh embodiment.

That is, similar to the seventh embodiment, in a state where the bias voltage is applied to the first input terminal 4 such that the predetermined current flows into the first and fourth MOS transistors 1a and 1b, turning ON/OFF of the second and third MOS transistors 2a and 2b is synchronized and controlled, according to the switch voltage applied to the second input terminal 5.

The operation of the current source circuit 1000 when the rectangular-wave switch voltage is applied to the second input terminal 5 and the second and third MOS transistors 2a and 2b are turned on is basically the same as that of the current source circuit 700 according to the seventh embodiment.

In this case, when a state of the second MOS transistor 2a is switched from an OFF state to an ON state, the drain voltage of the first MOS transistor 1a decreases from the power supply voltage to the voltage of the load 10. The voltage of the load 10 increases as the output current increases.

Therefore, when the output current increases, the variation width of the drain voltage of the first MOS transistor is decreases.

Therefore, in the tenth embodiment, as described above, the output amplitude of the inverter 12a is controlled by the level shift circuit 14a, such that the output amplitude decreases as the output current increases. Thereby, an increase ratio of the gate voltage of the first MOS transistor 1a that is increased by the capacitor 13a is decreased.

That is, when the variation width of the drain voltage of the first MOS transistor 1a decreased, an increase ratio of the gate voltage of the first MOS transistor 1a that is increased by the capacitor 13a is decreased. Thereby, the magnitude of the function of the capacitor 13a and the magnitude of the function of the parasitic capacity can be approximated to each other.

Therefore, the current source circuit 1000 can perform an ON/OFF control on the output current such that the waveform of the output current is approximated to the rectangular wave, according to the rectangular-wave switch voltage.

As such, according to the current source circuit according to the present embodiment, the waveform of the output current that is output according to the input of the rectangular-wave signal can be approximated to the rectangular wave.

### Eleventh Embodiment

In an eleventh embodiment, an example of the configuration where an impact of the parasitic capacity of the MOS transistor on a current source circuit according to the eighth embodiment is further decreased will be described.

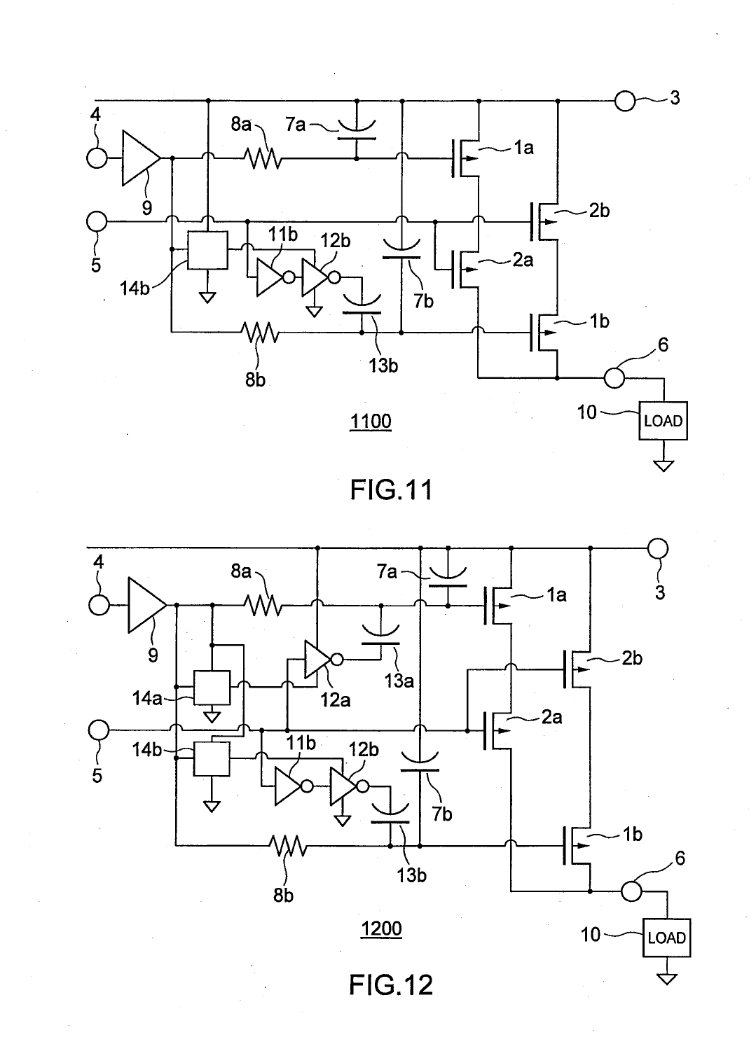

FIG. 11 is a circuit diagram showing an example of the configuration of the current source circuit according to the eleventh embodiment of the present invention. In FIG. 11, the same reference numerals as those of FIG. 8 denote the same components as those of the eighth embodiment.

As shown in FIG. 11, a current source circuit 1100 further includes a level shift circuit 14b, as compared with the current source circuit 800 of FIG. 8. The rest of the configuration of the current source circuit 1100 is the same as that of the current source circuit 800 according to the eighth embodiment.

The level shift circuit 14b is connected between an output terminal of the buffer amplifier 9 and a power supply terminal on a high-potential-side of the inverter 12b. The level shift circuit 14b controls amplitude of the inverter 12b according to an output of the buffer amplifier 9 (that is, according to the bias voltage).

For example, when the bias voltage is set such that the output current increases, the level shift circuit 14b increases a high-potential-side level of output levels of the inverter 12b to increase the amplitude of the inverter 12b. Meanwhile, when the bias voltage is set such that the output current decreases, the level shift circuit 14b decreases the high-potential-side level of the output levels of the inverter 12b to decrease the amplitude of the inverter 12b.

Similar to the eighth embodiment, the current source circuit 1100 supplies a current to the load 10 connected between the output terminal 6 and the ground, through the output terminal 6.

The operation of the current source circuit 1100 that has the above configuration is basically the same as that of the current source circuit 800 according to the eighth embodiment.

That is, similar to the eighth embodiment, in a state where the bias voltage is applied to the first input terminal 4 such that the predetermined current flows into the first and fourth MOS transistors 1a and 1b, turning ON/OFF of the second and third MOS transistors 2a and 2b is synchronized and controlled, according to the switch voltage applied to the second input terminal 5.

The operation of the current source circuit 1100 of when the rectangular-wave switch voltage is applied to the second input terminal 5 and the second and third MOS transistors 2a and 2b are turned on is basically the same as that of the current source circuit 800 according to the eighth embodiment.

In this case, when a state of the third MOS transistor 2b is switched from an OFF state to an ON state, the drain voltage of the fourth MOS transistor 1b increases from the ground voltage (zero voltage) to the voltage of the load 10. The voltage of the load 10 increases as the output current increases.

Therefore, when the output current increases, the variation width of the drain voltage of the fourth MOS transistor 1b increases.

Therefore, in the eleventh embodiment, as described above, the output amplitude of the inverter 12b is controlled by the level shift circuit 14b, such that the output amplitude increases as the output current increases. Thereby, an increase ratio of the gate voltage of the fourth MOS transistor 1b that is increased by the capacitor 13b is increased.

That is, when the variation width of the drain voltage of the fourth MOS transistor 1b is increased, a decrease ratio of the gate voltage of the fourth MOS transistor 1b that is increased by the capacitor 13b is increased. Thereby, the magnitude of the function of the capacitor 13b and the magnitude of the function of the parasitic capacity can be approximated to each other.

Therefore, the current source circuit 1100 can perform ON/OFF control on the output current such that the waveform of the output current is approximated to the rectangular wave, according to the rectangular-wave switch voltage.

As such, according to the current source circuit according to the present embodiment, the waveform of the output current that is output according to the input of the rectangular-wave signal can be approximated to the rectangular wave.

### Twelfth Embodiment

In a twelfth embodiment, an example of the configuration where the configurations of the tenth and eleventh embodiments are combined will be described.

FIG. 12 is a circuit diagram showing an example of the configuration of a current source circuit according to the twelfth embodiment of the present invention. In FIG. 12, the same reference numerals as those of FIGS. 10 and 11 denote the same components as those of the tenth and eleventh embodiments.

As shown in FIG. 12, a current source circuit 1200 further includes inverters 11b, 12a, and 12b and level shift circuits 14a and 14b. That is, the current source circuit 1200 has the configuration where the current source circuits 1000 and 1100 according to the tenth and eleventh embodiments are combined. The level shift circuit 14a and the level shift circuit 14b may be integrated.

Similar to the tenth and eleventh embodiments, the current source circuit 1200 supplies a current to the load 10 connected between the output terminal 6 and the ground, through the output terminal 6.

The operation of the current source circuit 1200 that has the above configuration is basically the same as those of the current source circuits 1000 and 1100 according to the tenth and eleventh embodiments.

That is, similar to the tenth and eleventh embodiments, in a state where the bias voltage is applied to the first input terminal 4 such that the predetermined current flows into the first and fourth MOS transistors 1a and 1b, turning ON/OFF of the second MOS transistor 2a and the third MOS transistor 2b is synchronized and controlled, according to the switch voltage applied to the second input terminal 5.

The operation of the current source circuit 1200 when the rectangular-wave switch voltage is applied to the second input terminal 5 and the second and third MOS transistors 2a and 2b are turned on is basically the same as those of the current source circuits 1000 and 1100 according to the tenth and eleventh embodiments.

In this case, when a state of the second MOS transistor 2a is switched from an OFF state to an ON state, the drain voltage of the first MOS transistor 1a decreases from the power supply voltage to the voltage of the load 10. The voltage of the load 10 increases as the output current increases.

Therefore, when the output current increases, the variation width of the drain voltage of the first MOS transistor is decreases.

Therefore, similar to the tenth embodiment, in the twelfth embodiment, the output amplitude of the inverter 12a is controlled by the level shift circuit 14a, such that the output amplitude decreases as the output current increases. Thereby, an increase ratio of the gate voltage of the first MOS transistor 1a that is increased by the capacitor 13a is decreased.

That is, when the variation width of the drain voltage of the first MOS transistor 1a is decreased, an increase ratio of the gate voltage of the first MOS transistor 1a that is increased by the capacitor 13a is decreased. Thereby, the magnitude of the function of the capacitor 13a and the magnitude of the function of the parasitic capacity can be approximated to each other.

When a state of the third MOS transistor 2b is switched from an OFF state to an ON state, the drain voltage of the fourth MOS transistor 1b increases from the ground voltage (zero voltage) to the voltage of the load 10. The voltage of the load 10 increases as the output current increases.

Therefore, when the output current increases, the variation width of the drain voltage of the fourth MOS transistor 1b increases.

Therefore, similar to the eleventh embodiment, in the twelfth embodiment, the output amplitude of the inverter 12b is controlled by the level shift circuit 14b, such that the output amplitude increases as the output current increases. Thereby, an increase ratio of the gate voltage of the fourth MOS transistor 1b that is increased by the capacitor 13b is increased.

That is, when the variation width of the drain voltage of the fourth MOS transistor 1b is increased, a decrease ratio of the gate voltage of the fourth MOS transistor 1b that is increased by the capacitor 13b is increased. Thereby, the magnitude of the function of the capacitor 13b and the magnitude of the function of the parasitic capacity can be approximated to each other.

Therefore, the current source circuit 1200 can perform an ON/OFF control on the output current such that the waveform of the output current is approximated to the rectangular wave, according to the rectangular-wave switch voltage.

As such, according to the current source circuit according to the present embodiment, the waveform of the output current that is output according to the input of the rectangular-wave signal can be approximated to the rectangular wave.

### Thirteenth Embodiment

In a thirteenth embodiment, an example of the specific circuit configuration of the level shift circuit 14a and the inverter 12a according to the fifth, tenth, and twelfth embodiments described above will be described.

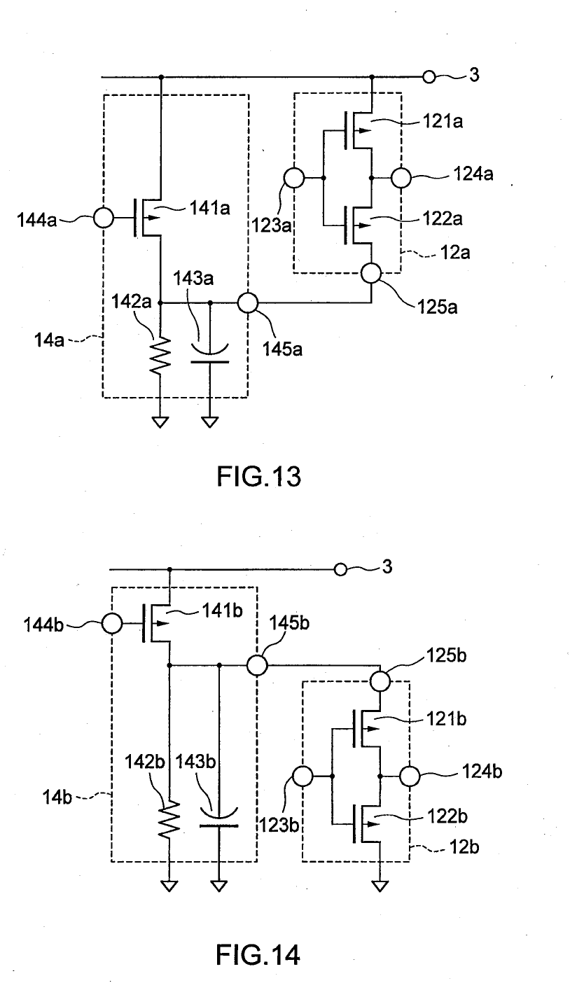

FIG. 13 is a circuit diagram showing an example of the specific circuit configuration of the level shift circuit 14a and the inverter 12a.

As shown in FIG. 13, the level shift circuit 14a has a MOS transistor 141a of which a source is connected to the voltage application terminal 3, a gate is connected to an input unit 144a, and a drain is connected to an output unit 145a; a resistor 142a that is connected between a drain of the MOS transistor 141a and a ground; and a capacitor 143a that is connected between the drain of the MOS transistor 141a and the ground.

The inverter 12a has a MOS transistor 121a of which a source is connected to the voltage application terminal 3, a gate is connected to an input unit 123a, and a drain is connected to an output unit 124a; and a MOS transistor 122a of which a source is connected to the output unit 124a, a gate is connected to the input unit 123a, and a drain is connected to a low-potential-side terminal 125a.

For example, when the bias voltage is set such that the output current increases, the level shift circuit 14a increases the voltage of the output unit 145a according to the voltage (output of the buffer amplifier 9) input to the input unit 144a. Thereby, the voltage of the low-potential-side terminal 125a increases, and a low-potential-side level of output levels of the inverter 12a increases and amplitude of the inverter 12a decreases.

Meanwhile, when the bias voltage is set such that the output current decreases, the level shift circuit 14a decreases the voltage of the output unit 145a according to the voltage (output of the buffer amplifier 9) input to the input unit 144a. Thereby, the voltage of the low-potential-side terminal 125a decreases, and the low-potential-side level of the output levels of the inverter 12a decreases and the amplitude of the inverter 12a increases.

As such, the level shift circuit 14a according to the present embodiment can control the amplitude of the inverter 12a according to the output of the buffer amplifier 9 (that is, according to the bias voltage).

### Fourteenth Embodiment

In a fourteenth embodiment, an example of the specific circuit configuration of the level shift circuit 14b and the inverter 12b according to the sixth, eleventh, and twelfth embodiments described above will be described.

FIG. 14 is a circuit diagram showing an example of the specific circuit configuration of the level shift circuit 14b and the inverter 12b.

As shown in FIG. 14, the level shift circuit 14b has a MOS transistor 141b of which a source is connected to the voltage application terminal 3, a gate is connected to an input unit 144b, and a drain is connected to an output unit 145b; a resistor 142b that is connected between a drain of the MOS transistor 141b and a ground; and a capacitor 143b that is connected between the drain of the MOS transistor 141b and the ground.

The inverter 12b has a MOS transistor 121b of which a source is connected to the a high-potential-side terminal 125b, a gate is connected to an input unit 123b, and a drain is connected to an output unit 124b; and a MOS transistor 122b of which a source is connected to the output unit 124b, a gate is connected to the input unit 123b, and a drain is connected to the voltage application terminal 3.

For example, when the bias voltage is set such that the output current increases, the level shift circuit 14b increases the voltage of the output unit 145b according to the output of the buffer amplifier 144b input to the input unit 144b. Thereby, the voltage of the high-potential-side terminal 125b increases, and a high-potential-side level of output levels of the inverter 12b increases and amplitude of the inverter 12b increases.

Meanwhile, when the bias voltage is set such that the output current decreases, the level shift circuit 14b decreases the voltage of the output unit 145b according to the output of the buffer amplifier 9 input to the input unit 144b. Thereby, the voltage of the high-potential-side terminal 125b decreases, the high-potential-side level of the output levels of the inverter 12b decreases and the amplitude of the inverter 12b decreases.

As such, the level shift circuit 14b according to the present embodiment can control the amplitude of the inverter 12b according to the output of the buffer amplifier 9 (that is, according to bias voltage).

In the individual embodiments described above, the case where the prescribed voltage is set as the power supply voltage and each MOS transistor is configured as the p-channel MOS transistor is described. However, the same functions and effects can be achieved, even when the prescribed voltage is set as the ground voltage and each MOS transistor is configured as an n-channel MOS transistor, and the polarities of the components of the current source circuit are reversed.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A current source circuit that supplies a current to a load connected to an output terminal, the current source circuit comprising:
a voltage application terminal that is applied with a prescribed voltage;
an output terminal that outputs the current;
a first MOS transistor of which a source is connected to the voltage application terminal;
a second MOS transistor of which a source is connected to a drain of the first MOS transistor and a drain is connected to the output terminal;
a third MOS transistor of which a source is connected to the voltage application terminal;
a fourth MOS transistor of which a source is connected to a drain of the third MOS transistor and a drain is connected to the output terminal;
a first input terminal that is applied with a bias voltage;
a resistor that is connected between the first input terminal and gates of the first and fourth MOS transistors; and
a second input terminal that is connected to gates of the second and third MOS transistors and is applied with a rectangular-wave switch voltage.

2. The current source circuit according to claim 1, wherein the resistor is divided into a first resistor that is connected between the first input terminal and the gate of the first MOS transistor, and a second resistor that is connected between the first input terminal and the gate of the fourth MOS transistor.

3. The current source circuit according to claim 2, wherein, in a state where the bias voltage is applied to the first input terminal such that the predetermined current flows into the first and fourth MOS transistors,
turning ON/OFF of the second MOS transistor and the third MOS transistor is synchronized and controlled, according to the switch voltage applied to the second input terminal.

4. The current source circuit according to claim 2, further comprising:
a inverter having an input connected to the second input terminal; and
a capacitor connected between an output of the inverter and the gate of the first MOS transistor.

5. The current source circuit according to claim 3, further comprising:
a inverter having an input connected to the second input terminal; and
a capacitor connected between an output of the inverter and the gate of the first MOS transistor.

6. The current source circuit according to claim 2, further comprising:
a first inverter having an input connected to the second input terminal;
a second inverter having an input connected to an output of the first inverter; and
a capacitor connected between an output of the second inverter and the gate of the first MOS transistor.

7. The current source circuit according to claim 3, further comprising:
a first inverter having an input connected to the second input terminal;
a second inverter having an input connected to an output of the first inverter; and
a capacitor connected between an output of the second inverter and the gate of the fourth MOS transistor.

8. The current source circuit according to claim 2, further comprising:
a first inverter having an input connected to the second input terminal;
a second inverter having an input connected to an output of the first inverter;
a first capacitor connected between an output of the first inverter and the gate of the first MOS transistor; and
a second capacitor connected between an output of the second inverter and the gate of the fourth MOS transistor.

9. The current source circuit according to claim 4, further comprising:
a level shift circuit that controls amplitude of the inverter according to the bias voltage,
wherein, when the bias voltage is set such that the output current increases, the level shift circuit controls the amplitude of the inverter to decrease, and
when the bias voltage is set such that the output current decreases, the level shift circuit controls the amplitude of the inverter to increase.

10. The current source circuit according to claim 5, further comprising:
a level shift circuit that controls amplitude of the inverter according to the bias voltage,
wherein, when the bias voltage is set such that the output current increases, the level shift circuit controls the amplitude of the inverter to decrease, and
when the bias voltage is set such that the output current decreases, the level shift circuit controls the amplitude of the inverter to increase.

11. The current source circuit according to claim 6, further comprising:
a level shift circuit that controls amplitude of the second inverter according to the bias voltage,
wherein, when the bias voltage is set such that the output current increases, the level shift circuit controls the amplitude of the second inverter to increases, and
when the bias voltage is set such that the output current decreases, the level shift circuit controls the amplitude of the second inverter to decrease.

12. The current source circuit according to claim 7, further comprising:
a level shift circuit that controls amplitude of the second inverter according to the bias voltage,
wherein, when the bias voltage is set such that the output current increases, the level shift circuit controls the amplitude of the second inverter to increases, and
when the bias voltage is set such that the output current decreases, the level shift circuit controls the amplitude of the second inverter to decrease.

13. The current source circuit according to claim 8, further comprising:
a first level shift circuit that controls amplitude of the first inverter according to the bias voltage; and
a second level shift circuit that controls amplitude of the second inverter according to the bias voltage,
wherein, when the bias voltage is set such that the output current increases, the first level shift circuit controls the amplitude of the first inverter to decrease, and
when the bias voltage is set such that the output current decreases, the first level shift circuit controls the amplitude of the first inverter to increase, and
wherein, when the bias voltage is set such that the output current increases, the second level shift circuit controls the amplitude of the second inverter to increases, and
when the bias voltage is set such that the output current decreases, the second level shift circuit controls the amplitude of the second inverter to decrease.

14. The current source circuit according to claim 1, wherein the prescribed voltage is power supply voltage, and the first to fourth MOS transistors are p-channel MOS transistors.

15. The current source circuit according to claim 2, wherein the prescribed voltage is power supply voltage, and the first to fourth MOS transistors are p-channel MOS transistors.

16. The current source circuit according to claim 3, wherein the prescribed voltage is power supply voltage, and the first to fourth MOS transistors are p-channel MOS transistors.

17. The current source circuit according to claim 1, wherein the prescribed voltage is ground voltage, and the first to fourth MOS transistors are n-channel MOS transistors.

18. The current source circuit according to claim 2, wherein the prescribed voltage is ground voltage, and the first to fourth MOS transistors are n-channel MOS transistors.

19. The current source circuit according to claim 3, wherein the prescribed voltage is ground voltage, and the first to fourth MOS transistors are n-channel MOS transistors.
